(19) United States
(12) Patent Application Publication
(10) Pub. No.: US 2019/0114413 A1
(43) Pub. Date: Apr. 18, 2019

(54) SERVER, CAMERA AND METHOD

(71) Applicant: TOSHIBA VISUAL SOLUTIONS CORPORATION, Misawa-shi (JP)

(72) Inventor: Satoshi Ozaki, Yokohama Kanagawa (JP)

(21) Appl. No.: 15/852,793

(22) Filed: Dec. 22, 2017

(30) Foreign Application Priority Data
Oct. 12, 2017 (JP) 2017-198506

(51) Int. Cl. G06F 21/44; H04N 21/4223; H04N 21/258; H04N 21/426; H04N 21/41; H04N 21/4367; H04N 21/436

(52) U.S. Cl. CPC G06F 21/44; H04N 21/4223; H04N 21/25816; G06F 21/606; H04N 21/4126; H04N 21/4367; H04N 21/43615; H04N 21/42684

(57) ABSTRACT

According to one embodiment, a server includes a transmitter. The transmitter transmits a first image to a first electronic apparatus, if the request is received from the first electronic apparatus and if the first electronic apparatus is associated with a first identifier of the first camera. The first image is captured by the first camera when a camera identifier of the first camera is the first identifier. The transmitter transmits a second image to a second electronic apparatus, if the request is received from the second electronic apparatus and if the second electronic apparatus is associated with a second identifier of the first camera. The second image is captured by the first camera when the camera identifier of the first camera is the second identifier.

### CROSS-REFERENCE TO RELATED APPLICATIONS

This application is based upon and claims the benefit of priority from Japanese Patent Application No. 2017-198506, filed Oct. 12, 2017, the entire contents of which are incorporated herein by reference.

### FIELD

Embodiments described herein relate generally to a server, a camera and a method.

### BACKGROUND

Recently, cameras called, for example, IP cameras or network cameras, have become widespread. These cameras comprise a communication function applied to, for example, the confirmation of the state of the inside of a house while the user is out. More specifically, cloud services for managing an image (moving image) transmitted (downloaded) from a camera and allowing the user to view (download) the image by a smartphone, etc., have become used.

For example, a camera provided inside a house may be taken away by an intruder. In preparation for this case, it is necessary to take measures to prevent the intruder who took away the camera from viewing the images captured by the camera or from deleting the images from the cloud server.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention,

FIG. 1 is a diagram showing an example of the use case of a monitoring system according to an embodiment.

FIG. 2 is a diagram showing an example of the configuration of a cloud server according to the embodiment.

FIG. 3 is a diagram showing an example of the functional block of the cloud server according to the embodiment.

FIG. 4 is a diagram showing an example of pairing data used by the cloud server according to the embodiment.

FIG. 5 is a diagram showing an example of recorded data stored in the cloud server according to the embodiment.

FIG. 6 is a diagram showing an example of the configuration of a camera device according to the embodiment.

FIG. 7 is a diagram showing an example of the functional block of the camera device according to the embodiment.

FIG. 8 is a sequence chart showing the flow of communication among the camera device, a mobile device and the cloud server at the time of the default setting of the camera device according to the embodiment.

FIG. 9 is a sequence chart showing the flow of communication between the camera device and the cloud server when an image is uploaded by the camera device and communication between the mobile device and the cloud server when an image is downloaded by the mobile device according to the embodiment.

FIG. 10 is a first diagram for explaining an operation for viewing an image by authentication tokens in the monitoring system according to the embodiment.

FIG. 11 is a second diagram for explaining an operation for viewing an image by authentication tokens in the monitoring system according to the embodiment.

FIG. 12 is a first diagram for explaining a mechanism for adding a mobile device to be associated with the camera device provided in the monitoring system according to the embodiment.

FIG. 13 is a second diagram for explaining a mechanism for adding a mobile device to be associated with the camera device provided in the monitoring system according to the embodiment.

FIG. 14 is a flowchart showing the procedure of an operation performed by the cloud server when a request for viewing an image is received from a mobile device according to the embodiment.

FIG. 15 is a flowchart showing the procedure of an operation performed by the camera device 1 for uploading an image to the cloud server 3 according to the embodiment.

### DETAILED DESCRIPTION

In general, according to one embodiment, a server includes a receiver and a transmitter. The receiver is configured to receive a request for an image captured by a first camera from an electronic apparatus. The transmitter configured to: transmit a first image to a first electronic apparatus, if the request is received from the first electronic apparatus and if the first electronic apparatus is associated with a first identifier of the first camera, wherein the first image is captured by the first camera when a camera identifier of the first camera is the first identifier; and transmit a second image to a second electronic apparatus, if the request is received from the second electronic apparatus and if the second electronic apparatus is associated with a second identifier of the first camera, wherein the second image is captured by the first camera when the camera identifier of the first camera is the second identifier.

Various embodiments will be described hereinafter with reference to the accompanying drawings.

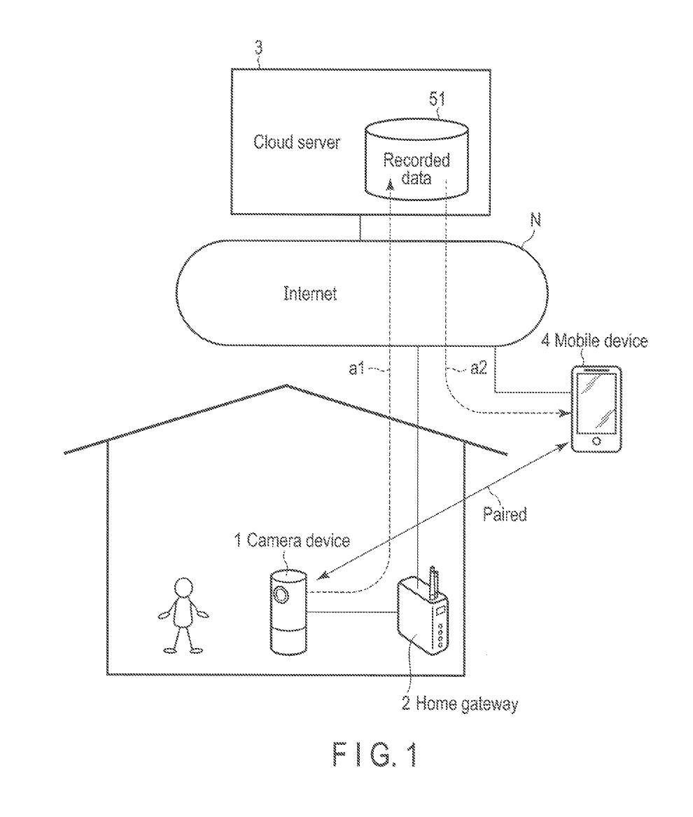

FIG. 1 is a diagram showing an example of the use case of a monitoring system according to the present embodiment.

This monitoring system is a system structured to meet the needs for, for example, the confirmation of the state of the inside of a house while the user is out. For example, a camera device 1 provided inside a house comprises a wireless communication function compliant with the IEEE 802.11 standard, and is capable of communicating with a cloud server 3 connected to the Internet N via a home gateway 2. Thus, the camera device 1 is capable of transmitting (uploading) the captured image (moving image) to the cloud server 3 (a1 in FIG. 1). Recorded data 51 shown in FIG. 1 is a data structure including the images received from the camera device 1. The details of the recorded data 51 are explained later.

The camera device 1 may continuously capture an image. Alternatively, the camera device 1 may adaptively capture an image based on, for example, the detection values of various sensors. Thus, the camera device 1 may either continuously or adaptively upload an image to the cloud server 3. Alternatively, the camera device 1 may continuously capture an image and adaptively upload an image. For example, when an abnormality is detected by a sensor, the camera device 1 may upload the image which is captured a certain period before the detected time, and the subsequent captured images. Alternatively, the camera device 1 may continuously capture and upload an image, and further, for example, transmit the detection values of various sensors as attached information as well as the image. The camera device 1 may comprise a function for recording sound and upload the recorded sound as well as an image to the cloud server 3.

An identifier capable of identifying each camera device 1 is provided to the camera device 1. The identifier is capable of at least identifying the camera device, and further, can be updated in accordance with a specific condition. In the following embodiment, this specification explains an example in which the identifier is device identification data (ID). The identifier. (for example, device ID) may be set based on identification information which is added when the camera device is manufactured, such as a manufacturing number, a part number and a MAC address, or may be set in other arbitrary ways.

The images uploaded to the cloud server 3 can be viewed (downloaded) by a mobile device 4 which comprises a communication function for performing communication via the Internet N and which is paired (associated) with the camera device 1 under the control of the cloud server 3 (a2 in FIG. 1). Thus, the user who carries the mobile device 4 can confirm the state of the inside of the house in which the camera device 1 is provided in real time. Further, the user can confirm the state at an arbitrary past time point. For example, the user can view an image from the current time point or an arbitrary past time point in either a forward direction or a backward direction temporally. The images stored in the cloud server 3 may be partially or entirely deleted by the mobile device 4. The mobile device 4 has to be a device at least comprising a communication function, such as a smart hone, or a notebook or tablet personal computer (PC).

That is to say, the cloud server 3 is a computer for providing a network service such that the captured images of the camera device 1 can be seen on only the specific mobile device 4.

The communication channel established between the camera device 1 and the cloud server 3 for uploading an image and the communication channel established between the mobile device 4 and the cloud server 3 for downloading an image are encrypted by, for example, transport layer security (TLS).

Note that, in this monitoring system, the camera device 1 holds only information for uploading an image to the cloud server 3, and does not hold information for downloading or deleting an image from the cloud server 3. Thus, in this monitoring system, even if the camera device 1 is taken away, the images captured by the camera device 1 are not viewed or deleted by the information held in the camera device 1. In this regard, a detailed explanation is made below.

In FIG. 1, the cloud server 3 is shown as a single device (computer) for convenience. The cloud server 3, however, is not limited to a single computer. For example, a plurality of computers which cooperate with each other to disperse the load may constitute the cloud server 3. One or some of the computers may be a computer (file server) for storing the recorded data 51.

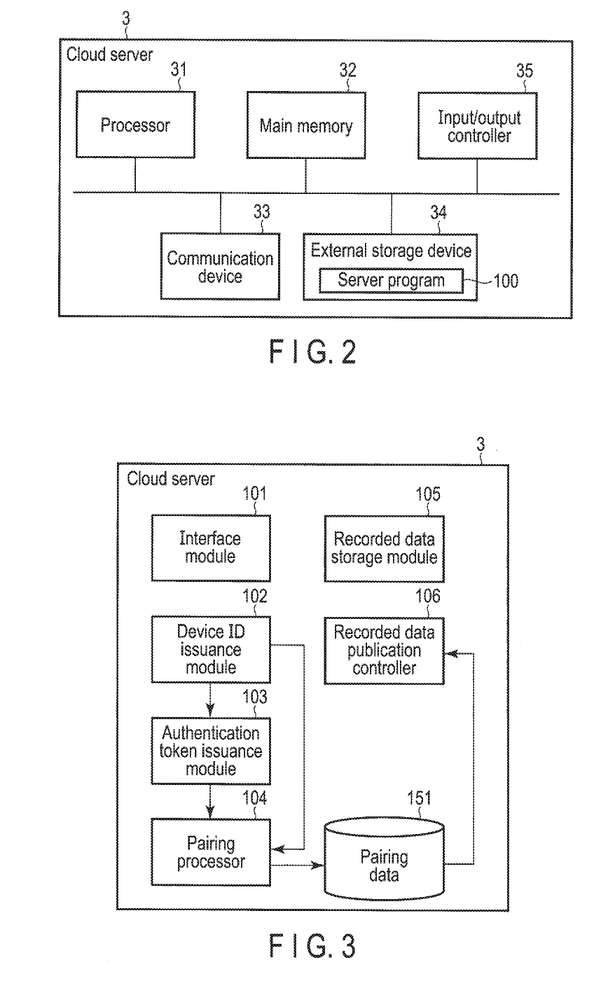

FIG. 2 is a diagram showing an example of the configuration of the cloud server 3.

As described above, a single computer may constitute the cloud server 3. Alternatively, a plurality of computers which cooperate with each other may constitute the cloud server 3. Thus, FIG. 2 conceptually shows the configuration of the cloud server 3.

As shown in FIG. 2, the cloud server 3 comprises a processor 31, a main memory 32, a communication device 33, an external storage device 34, an input/output controller 35, etc.

The processor 31 is a device which controls the components of the cloud server 3. The processor 31 is an electric circuit which loads various programs stored in the external storage device 34 into the main memory 32 and executes the programs. The programs include a server program 100 for providing the above network service. Here, only one processor 31 is shown for convenience. For example, a plurality of processors 31, however, may be provided to disperse the load.

For example, the main memory 32 is storage used as the work area of the server program 100 executed by the processor 31, such as a dynamic random access memory (DRAM).

The communication device 33 is a device which controls communication with the Internet N, for example, communication compliant with the IEEE 802.3 standard. The cloud server 3 communicates with the camera device 1 or the mobile device 4 via the Internet N by the communication device 33 in a procedure compliant with, for example, the TCP/IP standard.

The external storage device 34 is storage which stores various programs executed by the processor 31 and the recorded data 51 (including the images uploaded from the camera device 1), such as a hard disk drive (HDD) or a solid state drive (SSD). The external storage device 34 also stores various types of management data for performing the above network service.

For example, the input/output controller 35 is a device which receives data input from the keyboard or pointing device used by the administrator of the cloud server 3 and outputs data to the display used by the administrator. Thus, the input/output controller 35 is a device for providing the administrator of the cloud server 3, etc., with a human machine interface.

FIG. 3 is a diagram showing an example of the functional block of the cloud server 3.

As shown in FIG. 3, the cloud server 3 comprises an interface module 101, a device identification data (ID) issuance module 102, an authentication token issuance module 103, a pairing processor 104, a recorded data storage module 105, a recorded data publication controller 106, etc. These modules are structured on the cloud server 3 by loading the server program 100 from the external storage device 34 into the main memory 32 and executing the server program 100 by the processor 31. These modules are not limited to the server program 100, and may be partially structured as, for example, a dedicated electric circuit. The cloud server 3 comprises paring data 151. The paring data 151 is stored in the external storage device 34 as one of the various types of management data described above.

The interface module 101 is a module which performs a process for receiving a request from the camera device 1 and the mobile device 4 and sending back the result of the request. The device ID issuance module 102 is a module which performs a process for issuing a device ID to the camera device 1 or the mobile device 4 which is the issuance source when a request for issuing a device ID from the camera device 1 or the mobile device 4 is received by the interface module 101. The device ID issued by the device ID issuance module 102 is an. ID unique to this monitoring system. For example, the device ID is different from an ID uniquely allocated to each device, such as a MAC address. For example, the device ID of the camera device 1 may be updated by another request for issuing a device ID from the camera device 1. For example, when the camera device 1 is initialized (in other words, when default setting is applied to the camera device 1 again), a request for issuing a device ID is transmitted again from the camera device 1. The device ID issued by the device ID issuance module 102 is transmitted to the requester device by the interface module 101. In the cloud server 3, the device ID is passed to the authentication token issuance module 103 and the pairing processor 104.

In some cases, the invitation code described later is attached as a parameter, etc., to a request for issuing a device ID. When an invitation code is attached, and the attached invitation code matches the invitation code received from another device in advance, the device ID issuance module 102 passes the pairing processor 104 the information indicating that the transmission source of the invitation code is related to the device which requests to issue a device ID with the invitation code attached as a parameter, etc. Note that invitation codes from other devices are also received by the interface module 102 and are passed to the device ID issuance module 102. The device ID issuance module 102 may provide a time limit in an invitation code. For example, an invitation code may be valid only for a certain period after the invitation code is received.

The authentication token issuance module 103 is a module which performs a process for issuing an authentication token to the camera device 1 or the mobile device 4 which is the issuance source when a request for issuing an authentication token from the camera device 1 or the mobile device 4 is received by the interface module 101. The authentication token is information for authenticating the camera device 1 or the mobile device 4 when an image is uploaded or downloaded. Various existing methods may be employed for the authentication using authentication tokens. The device ID issued by the device ID issuance module 102 is attached as a parameter, etc., to a request for issuing an authentication token. When the attached device ID matches the device ID passed from the device ID issuance module 102, the authentication token. issuance module 103 issues an authentication token. The authentication token issuance module 103 may provide a time limit in the device ID passed from the device ID issuance module 102. More specifically, the issuance of an authentication token by each device ID may be restricted to a certain period after the device ID is issued by the device ID issuance module 102. The authentication token issued by the authentication token issuance module 103 is transmitted to the requester device by the interface module 101. In the cloud server 3, the authentication token as passed to the pairing processor 104 together with the device ID.

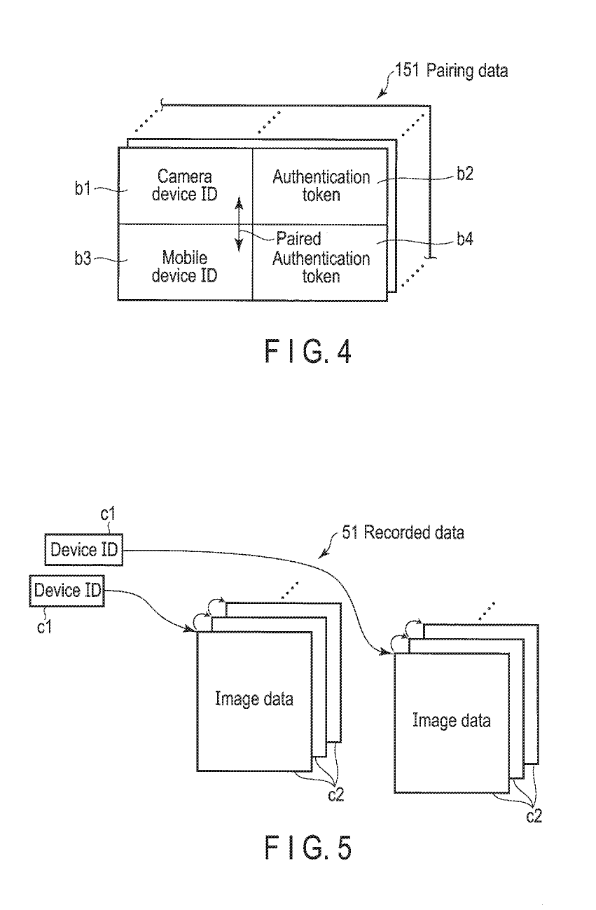

The paring processor 104 is a module which performs a process for associating (paring) the camera device 1 with the mobile device 4 based on the information passed from the device ID issuance module 102 (in other words, the information indicating that two devices are related to each other, specifically, each device ID) and the information passed from the authentication token issuance module 103 (specifically, authentication tokens). When the pairing processor 104 associates the camera device 1 with the mobile device 4, the pairing processor 104 records the correspondence between the camera device 1 and the mobile device 4 as the pairing data 151. FIG. 4 shows an example of the pairing data 151. As shown in FIG. 4, the pairing data 151 includes, for example, the device ID (b1) and the authentication token (b2) of the camera device 1, and the device ID (b3) and the authentication token (b4) of the mobile device 4. More specifically, the pairing data 151 holds the correspondence between the device ID (b1) of the camera device 1 and the device ID (b3) of the mobile device 4. FIG. 4 does not show an ID uniquely allocated to each device, such as a MAC address. This type of ID, however, may be further held as the pairing data 151 in at least one of the camera device 1 and the mobile device 4.

The recorded data storage module 105 is a module which performs a process for storing, as the recorded data 51, the image to be uploaded when a request for uploading the image from the camera device 1 is received by the interface module 101 and further when the image to be uploaded is received by the interface module 101 from the camera device 1. The authentication token issued by the authentication token issuance module 103 is attached as a parameter, attached information, etc., to the request for uploading the image or the transmitted image. The recorded data storage module 105 authenticates the camera device 1 based on the attached authentication token and stores the image transmitted from the camera device 1 in association with the device ID of the camera device 1. FIG. 5 shows an example of the recorded data 51. As shown in FIG. 5, as the recorded data 51, image data (c2) is accumulated in chronological order, using, for example, a device ID (c1) as a key. By connecting image data (c2) with, for example, address information, a large amount of image data can be continuously stored over a plurality of storage modules. FIG. 5 shows two device IDs (c1). These device IDs (c1) are device IDs issued with respect to, for example, two camera devices 1, respectively. The recorded data storage module 105 preferably comprises an encryption function to encrypt the image transmitted from the camera device 1 and store the encrypted image.

The recorded data publication controller 106 is a module which performs a process for creating a collection of uniform resource locators (URLs) for viewing an image from an arbitrary time point of some time points and sending back the created collection of URLs to the mobile device 4 which is the requester via the interface module 101 when a request for viewing an image from the mobile device 4 is received by the interface module 101. The created URLs may include, for example, a URL for viewing the current image, a URL for viewing a past image which was captured a certain period ago, such as 15 minutes, 30 minutes, one hour or two hours ago, and the subsequent images, and a URL for viewing a past image which is captured a certain period before an abnormality is detected by the sensors of the camera device 1, and the subsequent images. The authentication token issued by the authentication token issuance module 103 to the mobile device 4 is attached as a parameter, etc., to a request for viewing an image. The recorded data publication controller 106 refers to the pairing data 151 and detects the device ID (of the camera device 1) associated with the device ID of the mobile device 4 indicated by the attached authentication token. The recorded data publication controller 106 creates a collection of URLs for viewing the images stored as the recorded data 51 in association with the detected device ID by the recorded data storage module 105. The method to create the collection of URLs is not specified here since various existing methods may be employed. A desirable method is a method for creating an impermanent collection of URLs which has a valid period with a signature and can he used for a certain period only by the mobile device 4 which is the sender of the request for viewing an image. When images are encrypted for storage, for example, the images accessed by the URLs are transmitted to die mobile device 4 after the decryption by the recorded data storage module 105.

The recorded data publication controller 106 may either partially or entirely delete the images stored in the recorded data storage module 105 in response to a request for deleting the images from the mobile device 4 with an authentication token attached as a parameter, etc., for allowing the user to view the images. The recorded data publication controller 106 deals with only the authentication token of the mobile device 4 as an authentication token for allowing the images to be viewed. In other words, the authentication token of the camera device 1 is used to upload an image. By this authentication token, the images are not allowed to he viewed or deleted.

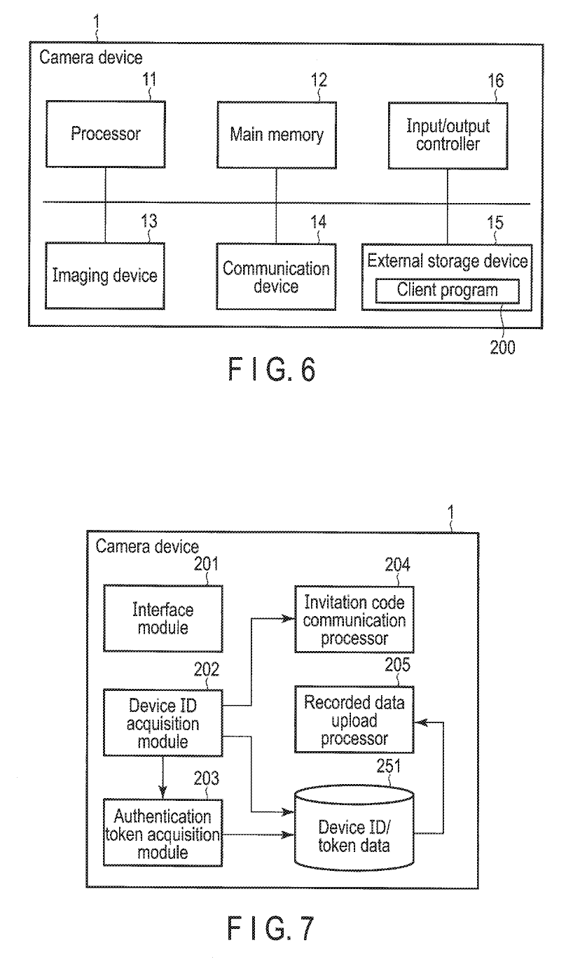

FIG. 6 is a diagram showing an example of the configuration of the camera device 1.

As shown in FIG. 6, the camera device 1 comprises a processor 11, a main memory 12, an imaging device 13, a communication device 14, an external storage device 15, an input/output controller 16, etc.

The processor 11 is a device which controls the components of the camera device 1. The processor 11 is an electric circuit which loads various programs stored in the external storage device 15 into the main memory 12 and executes the programs. The programs include a client program 200 for receiving the provision of the above network service. Here, only one processor 11 is shown for convenience. A plurality of processors 11, however, may be provided to, for example, disperse the load.

The main memory 12 is storage used as, for example, the work area of the client program 200 executed by the processor 11, such as a DRAM.

The imaging device 13 is a device which comprises an imaging element such as a change coupled device (CCD) and is capable of capturing an object. For example, the camera device 1 performs 24 captures per second by the imaging device 13, and obtains a moving image with a frame rate of 24 fps.

The communication device 14 is a device which controls wireless communication with the home gateway 2 or the mobile device 4, for example, wireless communication compliant with, for example, the IEEE 802.11 standard. The camera device 1 performs communication with the cloud server 3 via the home gateway 2 and the Internet N by the communication device 14 in a procedure compliant with, for example, the TCP/IP standard.

The external storage device 15 is storage which stores various programs executed by the processor 11, such as an HDD or an SSD. The external storage device 15 also temporarily stores the captured image to be uploaded to the cloud server 3.

The input/output controller 16 is a device which receives data input from the touchscreen display provided, for example, in the peripheral wall of the housing of the camera device 1 and outputs data to the touchscreen display. Thus, the input/output controller 16 is a device which provides the user of the camera device 1 with a human machine interface.

FIG. 7 is a diagram showing an example of the functional block of the camera device 1.

As shown in FIG. 7, the camera device 1 comprises an interface module 201, a device ID acquisition module 202, an authentication token acquisition module 203, an invitation code communication processor 204, a recorded data upload processor 205, etc. These modules are structured on the camera device 1 by loading the client program 200 from the external storage device 15 into the main memory 12 and executing the client program 200 by the processor 11. These modules are not limited to the client program 200, and may be partially structured as, for example, a dedicated electric circuit. The camera device 1 comprises device ID/token data 251. The device ID/token data 251 is data including the device IDs obtained by the device ID acquisition module 202 and the authentication tokens obtained by the authentication token acquisition module 203, and is stored in the external storage device 15.

The interface module 201 is a module which firstly performs a process for receiving a request from the user and presenting the result of the request. The interface module 201 is a module which secondly performs a process for communicating data with the cloud server 3 and the mobile device 4 (including the communication of various requests and the results of the requests).

The device ID acquisition module 202 is a module which performs a process for transmitting a request for issuing a device ID to the cloud server 3 via the interface module 201 and obtaining a device ID from the cloud server 3. The device ID is an ID unique to this monitoring system, and is different from an ID uniquely allocated to each device, such as a MAC address. A device ID is obtained by the device ID acquisition module 202 when, for example, a request for initializing the camera device 1 from the user is received by the interface module 201. For example, the device ID of the camera device 1 is updated every time the camera device 1 is initialized. The device ID acquisition module 202 passes the obtained device ID to the authentication token acquisition module 203 and the invitation code communication processor 204. The device ID acquisition module 202 stores the device ID obtained from the cloud server 3 as the device ID/token data 251.

The authentication token acquisition module 203 is a module which performs a process for transmitting a request for issuing an authentication token with the attached device ID obtained by the device ID acquisition module 202 as a parameter, etc., to the cloud server 3 via the interface module 201 and obtaining an authentication token from the cloud server 3. The authentication token acquisition module 203 records the authentication token obtained from the cloud server 3 as the device ID/token data 251. The authentication token acquisition module 203 obtains an authentication token when, for example, the device ID acquisition module 202 obtains a device ID. When a new authentication token is obtained, the authentication token acquisition module 203 updates the device ID/token data 251. Thus, in a manner similar to that of the operation for updating the device ID, the authentication token is updated every time the camera device 1 is initialized.

The invitation code communication processor 204 is a module which performs a process for creating an invitation code with a function for creating invitation codes, etc., transmitting the device ID obtained by the device ID acquisition module 202 and the created invitation code to the cloud server 3 via the interface module 201 and transmitting the created invitation code to the mobile device 4 (specified by the user) via the interface module 201. This invitation code is information used for a process for associating (pairing) the camera device 1 with the mobile device 4 in the cloud server 3. As the method for specifying the mobile device 4 by the user, for example, when an operation for associating the camera device 1 with the mobile device 4 is performed in the camera device 1, some mobile devices 4 present near the camera device 1 may be detected by wireless communication to be shown as options. The user may select the target mobile device 4 from the options.

The recorded data upload processor 205 is a module which performs a process for transmitting the image captured by the imaging device 13 to the cloud server 3 via the interface module 201. The recorded data upload processor 205 attaches the authentication token recorded as the device ID/token data 251 to the image as, for example, attached information, and transmits the image to the cloud server 3.

Even when the camera device 1 is taken away, and the authentication token is read, unauthorized viewing or deletion is not applied to the images captured by the camera device 1 (since permission to view or delete an image is not given by the authentication token of the camera device 1 as described above). Even when the camera device 1 is associated with the mobile device 4 (used by a person other than the valid user) by performing default setting again, the device ID of the camera device 1 is updated. Thus, the images which are captured by the camera device 1 and are stored in association with the device ID before update are not viewed or deleted without authentication.

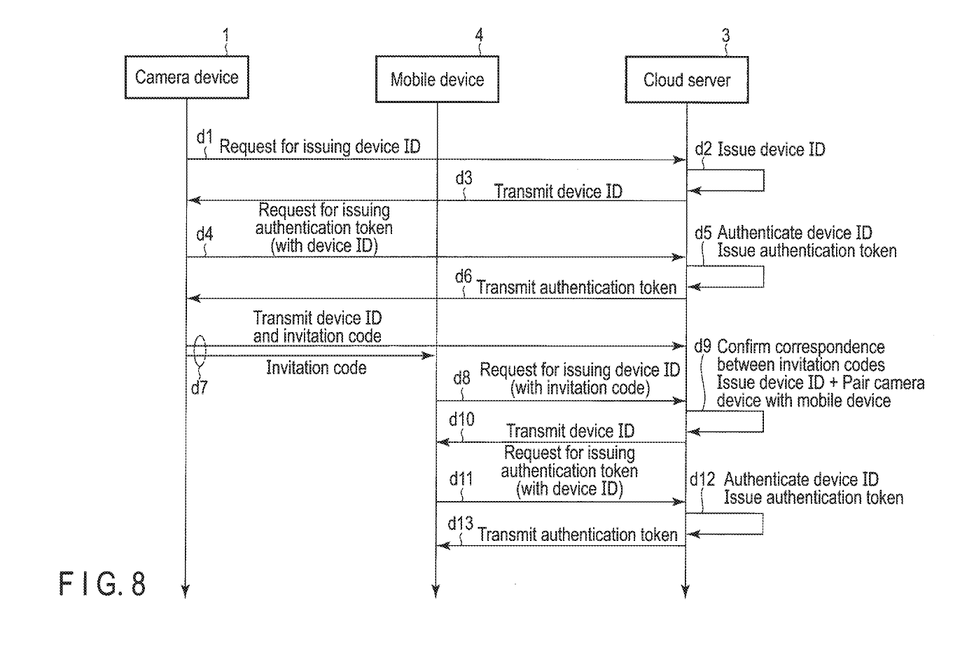

FIG. 8 is a sequence chart showing the flow of communication among the camera device 1, the mobile device 4 and the cloud server 3 at the time of the default setting of the camera device 1.

The default setting of the camera device 1 is performed when the camera device 1 is used for the first time. In addition, the default setting of the camera device 1 performed when the camera device 1 is initialized.

The camera device 1 transmits a request for issuing a device ID to the cloud server 3 (d1 in FIG. 8). The cloud server 3 which received the request issues a device ID with respect to the camera device 1 (d2 in FIG. 8) and sends back the device ID to the camera device 1 (d3 in FIG. 8).

The camera device 1 which obtained the device ID from the cloud server 3 transmits a request for issuing an authentication token to the cloud server 3, using the obtained device ID (d4 in FIG. 8). In response to the request, when the device ID received from the camera device 1 matches the issued device ID, the cloud server 3 issues an authentication token with respect to the camera device 1 (d5 in FIG. 8) and sends back the authentication token to the camera device 1 (d6 in FIG. 8).

Subsequently, the camera device 1 transmits the device ID and an invitation code to the cloud server 3 and transmits an invitation code to the mobile device 4 (specified by the user) (d7 in FIG. 8). The mobile device 4 transmits a request for issuing a device ID to the cloud server 3, using the invitation code received from the camera device 1 (d8 in FIG. 8).

When the cloud server 3 receives the request for issuing a device ID with the attached invitation code, and further when the attached invitation code matches the received invitation code, the cloud server 3 associates the camera device 1 which is the sender of the invitation code with the mobile device 4 which is the sender of the request for issuing a device ID with the invitation code, issues a device ID with respect to the mobile device 4 (d9 in FIG. 8), and sends back the device ID to the mobile device 4 (d10 in FIG. 8).

The mobile device 4 which obtained the device ID from the cloud server 3 transmits a request for issuing an authentication token to the cloud server 3, using the obtained de ice ID (d11 in FIG. 8). In response to the request, when the device ID received from the mobile device 4 matches the issued device ID, the cloud server 3 issues an authentication token with respect to the mobile device 4 (d12 in FIG. 8), and sends back the authentication token to the mobile device 4 (d13 in FIG. 8). At this time, the cloud server 3 records the correspondence between the device ID of the camera device 1 and the device ID of the mobile device 4.

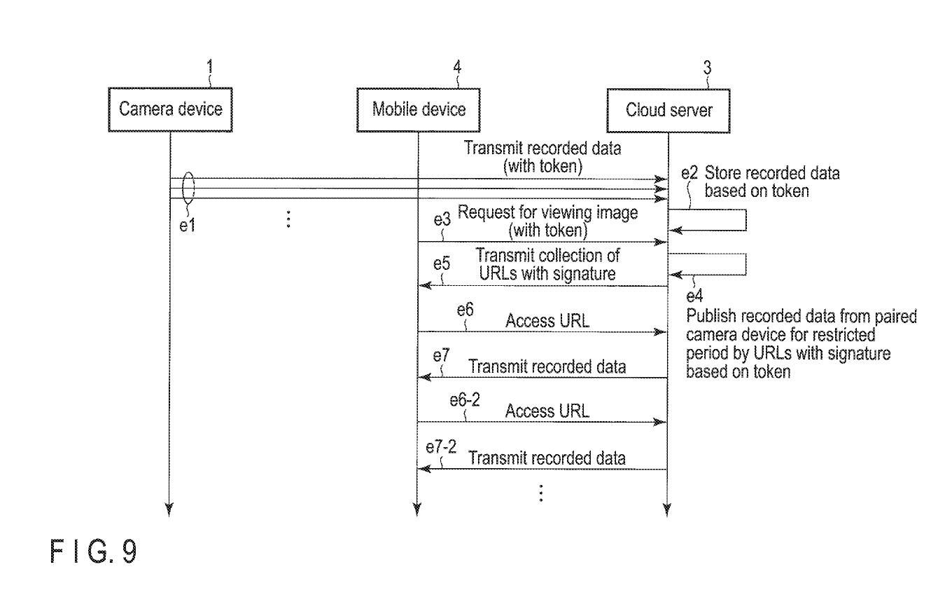

FIG. 9 is a sequence chart showing the flow of communication between the camera device 1 and the cloud server 3 when an image is uploaded by the camera device 1 and communication between the mobile device 4 and the cloud server 3 when an image is downloaded by the mobile device 4.

The camera device 1 transmits the captured image to the cloud server 3, using the authentication token obtained from the cloud server 3 (e1 in FIG. 9). Here, the authentication token obtained from the cloud server 3 is the last authentication token obtained from the cloud server 3. The cloud server 3 which received the image authenticates the camera device 1 based on the attached authentication token, and stores the received image in association with the device ID of the camera device 1 (e2 in FIG. 9

The mobile device 4 transmits a request for viewing an image to the cloud server 3, using the authentication token obtained from the cloud server 3 (e3 in FIG. 9). The cloud server which received the request authenticates the mobile device 4 based on the authentication token, detects the device ID of the camera device 1 associated with the device ID of the mobile device 4, creates a collection of URLs for viewing the images stored in association with the device ID, and sends back the collection of URLs to the mobile device 4 (e4 and eh in FIG. 9). For example, the collection of URLs is created as an impermanent collection which has a valid period with a signature and can be used for a certain period only by the authenticated mobile device 4.

The mobile device 4 accesses the cloud server 3, using the collection of URLs obtained from the cloud server 3 (e6 and e6-2 in FIG. 9). The accessed cloud server 3 transmits the target images to the mobile device 4 (e7 and e7-2 in FIG. 9).

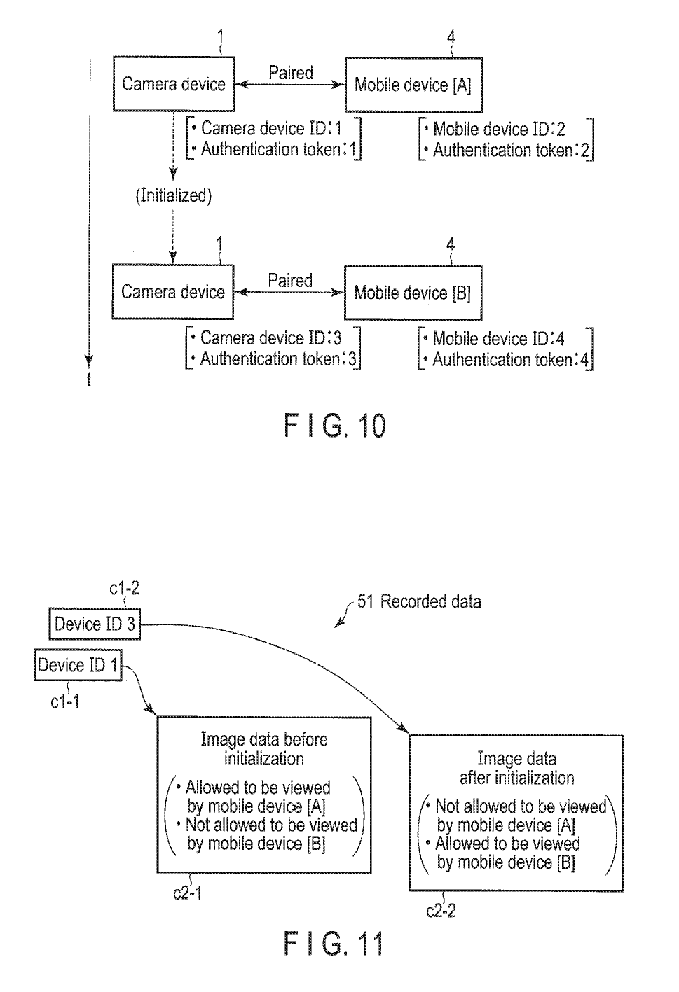

Now, this specification explains how an image is viewed by the mobile device 4 when the camera device 1 in which the operation has been already started is initialized, referring to FIG. 10 and FIG. 11.

As shown in FIG. 10, it is assumed that the camera device 1 obtains a device ID “1” from the cloud server 3, and obtains a device authentication token “1” from the cloud server 3, using the device ID “1”. Further, it is assumed that the camera device 1 in the state of the device ID “1” and the authentication token “1” is associated with a mobile device [A] 4. Further, it is assumed that the mobile device [A] 4 obtains a device ID “2” from the cloud server 3, and obtains an authentication token “2” from the cloud server 3, using the device ID “2”. On the cloud server 3, the device ID “1” of the camera device 1 and the device ID “2” of the mobile device [A] 4 are managed in association with each other.

It is assumed that subsequently the camera device 1 is initialized, and the camera device 1 newly obtains a device ID “3” from the cloud server 3, and obtains an authentication token “3” from the cloud server 3, using the device ID “3”. Further, it is assumed that the camera device 1 in the state of the device ID “3” and the authentication token “3” is associated with a mobile device [B] 4. Further, it is assumed that the mobile device [B] 4 obtains a device ID “4” from the cloud server 3, and obtains an authentication token “4” from the cloud server 3, using the device ID “4”. On the cloud server 3, the device ID “3” of the camera device 1 and the device ID “4” of the mobile device [B] 4 are managed in association with each other.

The mobile device [A] 4 transmits a request for viewing an image to the cloud server 3, using the authentication token “2”. The mobile device [B] 4 transmits a request for viewing an image to the cloud server 3, using the authentication token “4”. On the cloud server 3, the correspondence between the device ID “2” of the mobile device [A] 4 and the device ID “1” of the camera device 1 is managed, and further, the correspondence between the device ID “4” of the mobile device [B] 4 and the device ID “3” of the camera device 1 is managed. Thus, as shown in FIG. 11, by the mobile device [A] 4, only the images (c2-1) which are stored in association with the device ID “1” (c1-1) of the camera device 1 and are captured before the initialization of the camera device 1 can be viewed. By the mobile device [B] 4, only the images (c2-2) which are stored in association with the device ID “3” (c1-2) of the camera device 1 and are captured after the initialization of the camera device 1 can be viewed.

In other words, by the mobile device [A] 4, the images (c2-2) which are stored in association with the device ID “3” (c1-2) of the camera device 1 and are captured after the initialization of the camera device 1 cannot be viewed. By the mobile device [B] 4, the images (c2-1) which are stored. In association with the device ID “1” (c1-1) of the camera device 1 and are captured before the initialization of the camera device 1 cannot be viewed. Even when the camera device 1 is initialized in an unauthorized way, and an undesirable association is made between the camera device 1 and a mobile device 4 different from the mobile device 4 of the user, the images captured before the initialization cannot be viewed on the mobile device 4 different from the mobile device 4 of the user.

In this way, the monitoring system comprises a mechanism in which the images uploaded from the camera device 1 can be viewed only on the mobile device 4 associated (paired) with the camera device 1 by device IDs unique to the monitoring system. Thus, it is possible to prevent a person other than the valid user from viewing or deleting an image.

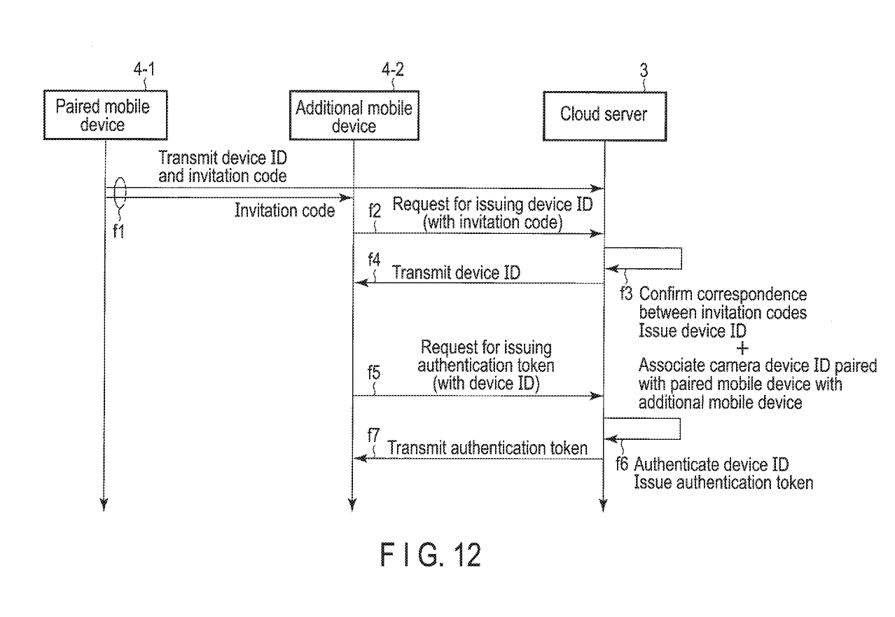

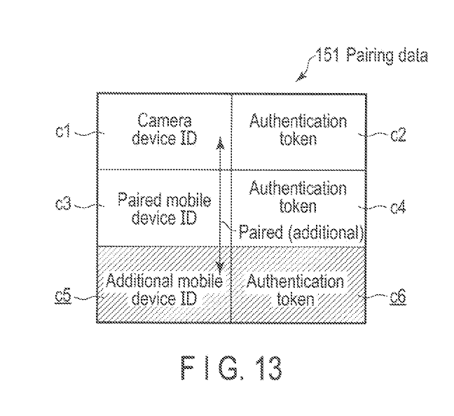

In some cases, after the default setting of the camera device 1, the user wants to add a mobile device 4 which allows the user to view the images captured by the camera device 1. To deal with this case, the monitoring system further comprises a mechanism for adding a mobile device 4 to be associated with the camera device 1. This mechanism is explained with reference to FIG. 12 and FIG. 13.

FIG. 12 is a sequence chart showing the flow of communication among a paired mobile device 4-1, an additional mobile device 4-2 and the cloud server 3 when the mobile device 4 to be associated with the camera device 1 is added.

When the additional mobile device 4-2 is associated with the camera device 1, the paired mobile device 4-1 already associated with the camera device 1 transmits a device ID and an invitation code to the cloud server 3, and transmits an invitation code to the additional mobile device 402 (f1 in FIG. 12). The additional mobile device 4-2 transmits a request for issuing a device ID to the cloud server 3, using the invitation code received from the paired mobile device 4-1 (f2 in FIG. 12).

When the cloud server 3 receives the request for issuing a device ID with the attached invitation code, and further when the attached invitation code matches the invitation code received from the paired mobile device 4-1, the cloud server 3 associates the camera device 1 associated with the paired mobile device 4-1 which is the sender of the invitation code with the additional mobile device 4-2 which is the sender of the request for issuing a device ID with the attached invitation code. The cloud server 3 issues a device ID with respect to the additional mobile device 4-2 (f3 in FIG. 12), and sends back the device ID to the additional mobile device 4 (f4 in. FIG. 12).

The additional mobile device 4-2 which obtained the, device ID from the cloud server 3 transmits a request for issuing an authentication token to the cloud server 3, using the obtained device ID (f5 in FIG. 12). In response to the request, when the device ID received from the additional mobile device 4-2 matches the issued device ID, the cloud server 3 issues an authentication token with respect to the additional mobile device 4-2 (f6 in FIG. 12), and sends back the authentication token to the additional mobile device 4-2 (f7 in FIG. 12). At this time, the cloud server 3 records the correspondence between the device ID of the camera device 1 and the device ID of the additional mobile device 4-2 in addition to the correspondence between the device ID of the camera device 1 and the device ID of the paired mobile device 4-1. FIG. 13 shows an example of the pairing data 151 after the addition of the additional mobile device 4-2. As shown in FIG. 13, after the addition of the additional mobile device 4-2, the pairing data 151 further includes the device ID (c5) and the authentication token (c6) of the additional mobile device 4-2. More specifically, after the addition of the additional mobile device 4-2, the paring data 151 further holds the correspondence between the device ID (c1) of the camera device 1 and the device ID (c5) of the additional mobile device 4-2.

After the above process, the user is allowed to view the images captured by the camera device 1 on the additional mobile device 4-2. The user is allowed to view the images which are captured by the camera device 1 even before the additional mobile device 4-2 is associated with the camera device 1. At the time of the default setting of the camera device 1, an invitation code may be transmitted from the camera device 1 to a plurality of mobile devices 4. The camera device 1 may be associated with the plurality of mobile devices 4.

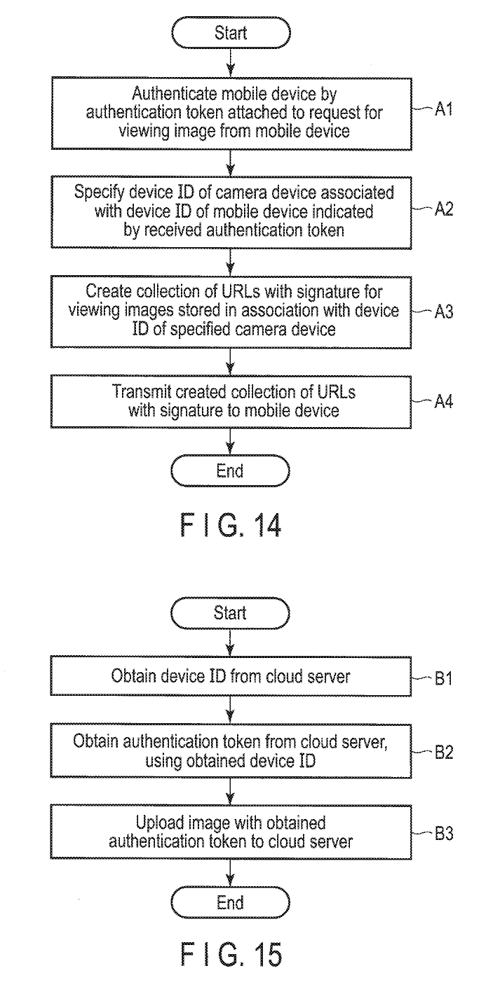

FIG. 14 is a flowchart showing the procedure of the operation of the cloud server 3 when the cloud server 3 receives a request for viewing an image from the mobile device 4.

When the cloud server 3 receives a request for viewing an image from the mobile device 4, the cloud server 3 authenticates the mobile device 4 by the authentication token attached to the request (block A1). Subsequently, the cloud server 3 specifies the device ID of the camera device 1 associated with the device ID of the mobile device 4 indicated by the authentication token (block A2).

When the cloud server 3 specifies the device ID of the camera device 1, the cloud server 3 creates a collection of URLs with a signature for viewing the images stored in association with the device ID (block A3), and transmits the created collection of URLs with a signature to the mobile device 4 (block A4).

FIG. 15 is a flowchart showing the procedure of an operation performed by the camera device 1 for uploading an image to the cloud server 3.

To upload an image to the cloud server 3, the camera device 1 obtains a device ID from the cloud server 3 (block B1). Subsequently, the camera device 1 obtains an authentication token from the cloud server 3, using the obtained device ID (block B2).

When the camera device 1 obtains the authentication token from the cloud server 3, the camera device 1 uploads the image with the authentication token (block B3).

In this manner, the monitoring system associates the camera device 1 with the mobile device 4 such that the images captured by the camera device 1 can be viewed by the mobile device 4, based on the device ID which is updated every time default setting is applied to the camera device 1. Thus, it is possible to prevent a person other than the valid user from viewing or deleting the images.

In the example of the above description, a device ID is obtained from the cloud server 3 at the time of the default setting of the camera device 1. The camera device 1, however, may generate a device ID and transmit a request for issuing an authentication token to the cloud server 3, using the device ID.

In the example of the above description, the camera device 1 is associated with the mobile device 4, using device IDs. The method for associating the camera device 1 with the mobile device 4, however, is not limited to this example.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server comprising:
a receiver configured to receive a request for an image captured by a first camera from an electronic apparatus; and
a transmitter configured to:
transmit a first image to a first electronic apparatus, if the request is received from the first electronic apparatus and if the first electronic apparatus is associated with a first identifier of the first camera, wherein the first image is captured by the first camera when a camera identifier of the first camera is the first identifier; and
transmit a second image to a second electronic apparatus, if the request is received from the second electronic apparatus and if the second electronic apparatus is associated with a second identifier of the first camera, wherein the second image is captured by the first camera when the camera identifier of the first camera is the second identifier.

2. The server of claim 1, wherein:
identifiers issued to the first camera are updated by at least one of an initialization or a default setting; and
the second identifier is obtained by initializing the first camera and updating the first identifier when the identifier of the first camera is the first identifier.

3. The server of claim 1, wherein:
the transmitter is further configured to transmit an authentication token to the first camera or the electronic apparatus to authenticate the first camera or the electronic apparatus; and
the identifier of the first camera comprises a value based on the authentication token.

4. The server of claim 1, wherein the transmitter is further configured to:
transmit the first identifier to the first camera in response to a identifier request issued at a first time point from the first camera; and
transmit the second identifier to the first camera in response to the identifier request issued at a second time point from the first camera.

5. The server of claim 1, further comprising a recorder configured to record a correspondence relationship between the first identifier of the first camera and an identifier of the first electronic apparatus, and a correspondence relationship between the second identifier of the first camera and an identifier of the second electronic apparatus.

6. The server of claim 1, further comprising a processor configured to associate the first identifier of the first camera with an identifier of a third electronic apparatus in response to an identifier request from the third electronic apparatus based on a first code from the first electronic apparatus.

7. A camera comprising:
an imaging device;
an acquisition device configured to obtain a camera identifier; and
a transmitter configured to:
transmit a first identifier and a first image to a server if the camera identifier of the camera is the first identifier, wherein the first image is captured by the imaging device when the camera identifier of the camera is the first identifier; and
transmit a second identifier and a second image to the server if the camera identifier of the camera is the second identifier, wherein the second image is captured by the imaging device when the camera identifier of the camera is the second identifier.

8. The camera of claim 7, wherein:
the acquisition device is further configured to obtain an updated camera identifier of the camera in accordance with at least one of an initialization and a default setting of the camera; and
the second identifier is obtained by initializing the camera and updating the first identifier when the camera identifier of the camera is the first identifier.

9. The camera of claim 7, further comprising a receiver configured to receive an authentication token for causing the server to authenticate the camera from the server.

10. A method executed by a server, the method comprising:
receiving a request for an image captured by a first camera from an electronic apparatus associated with the first camera;
transmitting a first image to a first electronic apparatus, if the request is received from the first electronic apparatus and if the first electronic apparatus is associated with a first identifier of the first camera, wherein the first image is captured by the first camera when a camera identifier of the first camera is the first identifier; and
transmitting a second image to a second electronic apparatus, if the request is received from the second electronic apparatus and if the second electronic apparatus is associated with a second identifier of the first camera, wherein the second image is captured by the first camera when the camera identifier of the first camera is the second identifier.

11. A method executed by a camera with an imaging device, the method comprising:
obtaining a camera identifier;
transmitting a first identifier and a first image to a server if the camera identifier of the camera is the first identifier, wherein the first image is captured by the imaging device when the camera identifier of the camera is the first identifier; and
transmitting a second identifier and a second image to the server if the camera identifier of the camera is the second identifier, wherein the second image is captured by the imaging device when the camera identifier of the camera is the second identifier.
